(19) United States
(12) Patent Application Publication
(10) Pub. No.: US 2024/0291626 A1
(43) Pub. Date: Aug. 29, 2024

(54) METHOD FOR BEAM INFORMATION INDICATION

(71) Applicant: ZTE CORPORATION, Shenzhen (CN)

(72) Inventors: Shuang ZHENG, Shenzhen (CN); Nan ZHANG, Shenzhen (CN); Wei CAO, Shenzhen (CN); Ziyang LI, Shenzhen (CN)

(73) Assignee: ZTE CORPORATION, Shenzhen (CN)

(21) Appl. No.: 18/604,769

(22) Filed: Mar. 14, 2024

Related U.S. Application Data
(63) Continuation of application No. PCT/CN2022/073589, filed on Jan. 24, 2022.

(51) Int. Cl. H04L 5/00; H04W 72/23

(52) U.S. Cl. CPC H04L 5/0094; H04W 72/23

(57) ABSTRACT

Method, device and computer program product for wireless communication are provided. A method includes: receiving, by a network node, a beam indication for network for one or more links comprising at least one of: a first communication link from a wireless communication node to the network node; a second communication link from the network node to the wireless communication node; a first forwarding link from the wireless communication node to the network node; a second forwarding link from the network node to the wireless communication node; a third forwarding link from the network node to a user equipment, UE; or a fourth forwarding link from the user equipment to the network node.

### CROSS-REFERENCE TO RELATED PATENT APPLICATIONS

This application is a Continuation of PCT Application No. PCT/CN2022/073589, filed Jan. 24, 2022, incorporated herein by reference in its entirety.

### TECHNICAL FIELD

This document is directed generally to wireless communications, including but not limited to 5^{th} generation (5G) communications.

### BACKGROUND

As the new radio (NR) system moves to higher frequencies (around 4 GHz for FR1 deployments and above 24 GHz for FR2), propagation conditions degrade compared to lower frequencies exacerbating the coverage challenges. As a result, further densification of cells may be necessary. While the deployment of regular full-stack cells is preferred, it may not always be a possible (e.g., not availability of backhaul) or economically viable option. To provide blanket coverage in cellular network deployments with relatively low cost, RF repeaters with full-duplex amplify-and-forward operation.

### SUMMARY

RF repeaters have been used in 2G, 3G and 4G deployments to supplement the coverage provided by regular full-stack cells with various transmission power characteristics. They constitute the simplest and most cost-effective way to improve network coverage. Within RF repeaters, there are different categories depending on the power characteristics and the amount of spectrum that they are configured to amplify (e.g., single band, multi-band, etc.). RF repeaters are a non-regenerative type of relay nodes and they simply amplify-and-forward everything that they receive. RF repeaters are typically full-duplex nodes and they do not differentiate between UL and DL from a transmission or reception standpoint.

The main advantages of RF repeaters are their low-cost, their ease of deployment and the fact that they do not increase latency. The main disadvantage is that they amplify signal and noise and, hence, may contribute to an increase of interference (pollution) in the system.

Another common property of the NR systems is the use of multi-beam operation with associated beam management in the higher frequency bands defined for TDD. The multi-antenna techniques consisting of massive MIMO for FR1 and analog beamforming for FR2 assist in coping with the challenging propagation conditions of these higher frequency bands. The RF repeater without beam management functions cannot provide beamforming gain in its signal forwarding.

This document relates to methods for beam information indication, devices thereof and systems thereof.

One aspect of the present disclosure relates to a wireless communication method. In an embodiment, the wireless communication method includes: receiving, by a network node, a beam indication for a network for one or more links comprising at least one of:
a first communication link from a wireless communication node to the network node;
a second communication link from the network node to the wireless communication node;
a first forwarding link from the wireless communication node to the network node;
a second forwarding link from the network node to the wireless communication node;
a third forwarding link from the network node to a user equipment, UE; or
a fourth forwarding link from the user equipment to the network node.

Another aspect of the present disclosure relates to a wireless communication method. In an embodiment, the wireless communication method includes: transmitting, by a wireless communication node to a network node, a beam indication for a network for one or more links comprising at least one of:
a first communication link from the wireless communication node to the network node;
a second communication link from the network node to the wireless communication node;
a first forwarding link from the wireless communication node to the network node;
a second forwarding link from the network node to the wireless communication node;
a third forwarding link from the network node to a user equipment, UE; or
a fourth forwarding link from the user equipment to the network node.

Another aspect of the present disclosure relates to a wireless communication node. In an embodiment, the wireless communication node includes a communication unit. The communication unit is configured to: receive a beam indication for a network for one or more links comprising at least one of:
a first communication link from the wireless communication node to the network node;
a second communication link from the network node to the wireless communication node;
a first forwarding link from the wireless communication node to the network node;
a second forwarding link from the network node to the wireless communication node;
a third forwarding link from the network node to a user equipment, UE; or
a fourth forwarding link from the user equipment to the network node.

Another aspect of the present disclosure relates to a wireless communication node. In an embodiment, the wireless communication node includes a communication unit. The communication unit is configured to: transmit, to a network node, a beam indication for a network for one or more links comprising at least one of:
a first communication link from the wireless communication node to the network node;
a second communication link from the network node to the wireless communication node;
a first forwarding link from the wireless communication node to the network node;
a second forwarding link from the network node to the wireless communication node;
a third forwarding link from the network node to a user equipment, UE; or
a fourth forwarding link from the user equipment to the network node.

Various embodiments may preferably implement the following features:

Preferably or in some embodiments, the beam indication for the links are determined by a Transmission Configuration Indicator, TCI.

Preferably or in some embodiments, a first type TCI is associated to each of the links.

Preferably or in some embodiments, a second type TCI is associated to the one or more links.

Preferably or in some embodiments, the all or partially signal of beam indication is transmitted by an Operations Administration and Maintenance, OAM from network to network node.

Preferably or in some embodiments, TCI states are configured by Radio Resource Control, RRC, signaling.

Preferably or in some embodiments, multiple sets of first type of TCI states are configured by Radio Resource Control, RRC, signaling for different links.

Preferably or in some embodiments, each of second type TCI state comprises a first part and a second part, the first part configures information for at least one of the first or second communication link, and a second part configures information for at least one of the first, second, third or fourth forwarding link.

Preferably or in some embodiments, each of second type TCI state configuration comprises a first part and a second part, the first part configures information for at least one of the first, second, third or fourth forwarding link, and a second part configures information for at least one of the first, second, third or fourth forwarding link.

Preferably or in some embodiments, one or multiple of the first type TCI states for different link is selected by corresponding MAC CE command.

Preferably or in some embodiments, one or multiple of the second type TCI states for different link combination is selected by corresponding MAC CE command.

Preferably or in some embodiments, each of second type TCI state comprises a first part and a second part, the first part configures information for at least one of the first, second communication link, and a second part configures information for at least one of the first, second, third or fourth forwarding link.

Preferably or in some embodiments, each of second type TCI state comprises a first part and a second part, the first part configures information for at least one of the first, second, third or fourth forwarding link, and a second part configures information for at least one of the first, second, third or fourth forwarding link.

Preferably or in some embodiments, a higher layer parameter is used to indicate that one of TCI states is selected by a MAC CE command for at least one of the first, second, third or fourth forwarding link.

Preferably or in some embodiments, the DCI for indicating the TCI state is scrambled by using a first Radio Network Temporary Identifier, RNTI, and the first RNTI is different from a second RNTI for scrambling DCI corresponding to a communication unit of the network node.

Preferably or in some embodiments, the DCI for indicating the TCI state for the at least one of communication link is scrambled by using a first Radio Network Temporary Identifier, RNTI, and the first RNTI is different from a second RNTI for scrambling DCI for indicating the TCI state for the at least one of forwarding link.

Preferably or in some embodiments, the DCI for indicating the TCI state has a first DCI format, and the first DCI format is different from a second DCI format DCI corresponding to a communication unit of the network node.

Preferably or in some embodiments, the DCI for indicating the TCI state in the first DCI format comprises one or more TCIs for one or more of the first, second, third and fourth forwarding links respectively.

Preferably or in some embodiments, a higher layer parameter is used to indicate that the indication of beam information via DCI is enabled.

Preferably or in some embodiments, the indicated TCI state via DCI is configured by OAM.

Preferably or in some embodiments, the beam indication is determined by spatial relations.

Preferably or in some embodiments, the spatial relations are configured by Radio Resource Control, RRC, signaling.

Preferably or in some embodiments, the spatial relations are activated by a MAC CE command, and one of the activated spatial relations is selected by DCI.

Preferably or in some embodiments, one of the spatial relations is selected by a MAC CE command.

Preferably or in some embodiments, a higher layer parameter is used to indicate that the one of the spatial relations is selected by a MAC CE command.

Preferably or in some embodiments, the DCI for selecting the activated spatial relations comprises a time-frequency resource indication and/or a beam spatial parameter.

Preferably or in some embodiments, a higher layer parameter is used to indicate that the one of the activated spatial relations is selected by an SRI field in the DCI.

Preferably or in some embodiments, the one of the activated spatial relations is selected by a field in DCI.

Preferably or in some embodiments, the beam indication of one or more of the first, second, third, and fourth forwarding links is identical to the beam indication of one or more of the first and second communication links.

Preferably or in some embodiments, the wireless communication nodes further comprise a processor, wherein the processor is configured to receive or transmit the beam indication via the communication unit.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

### BRIEF DESCRIPTION OF THE DRAWINGS

The above and other aspects and their implementations are described in greater detail in the drawings, the descriptions, and the claims.

FIG. 1A shows a schematic diagram of a downlink beam indication mechanism according to an embodiment of the present disclosure.

FIG. 1B shows a schematic diagram of an uplink beam indication mechanism according to an embodiment of the present disclosure.

FIG. 2 shows communication links and forwarding links according to an embodiment of the present disclosure.

FIG. 3 shows a method for beam management procedure according to an embodiment of the present disclosure.

FIG. 4 shows an example of a schematic diagram of a wireless terminal according to an embodiment of the present disclosure.

FIG. 5 shows an example of a schematic diagram of a wireless network node according to an embodiment of the present disclosure.

FIG. 6 shows a tree diagram according to embodiments of the present disclosure.

FIGS. 7 and 8 show flowcharts of wireless communication method according to an embodiment of the present disclosure.

### DETAILED DESCRIPTION

In embodiments of the present disclosure, to cope with unwanted interference, a smart node can be considered, which makes use of the control information from its connected BS to enable an intelligent amplify-and-forward operation.

In an embodiment, the beam information of the downlink (DL) and uplink (UL) are separately indicated. In general, beam information can refer to either the index of a reference signal (e.g., CSI-RS), an antenna port, a codebook, spatial information or quasi-co location information. According to the indication for beam information (e.g., beam indication), a network node may update its own transmission/reception status in the spatial domain.

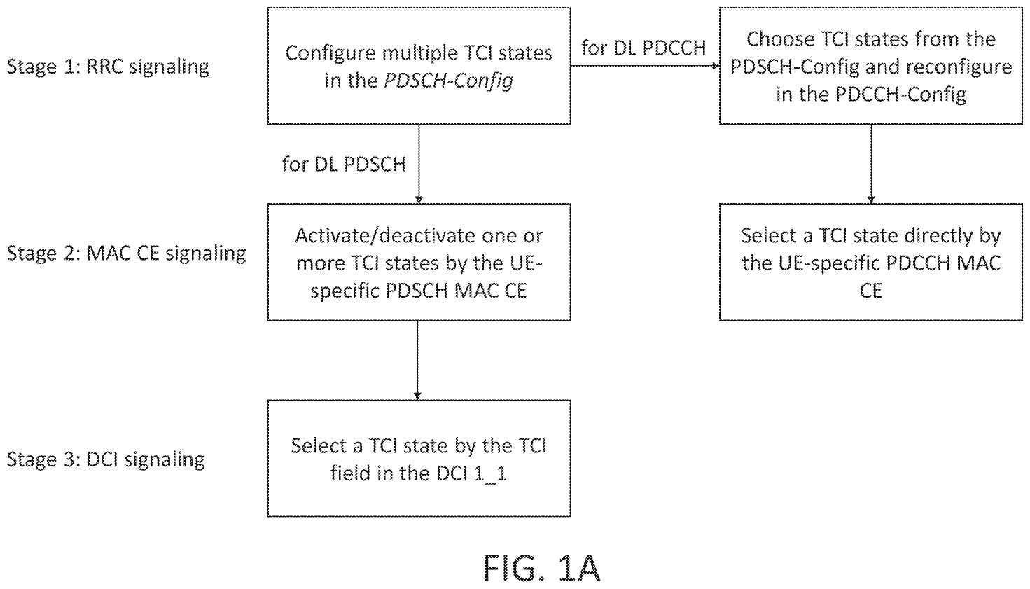

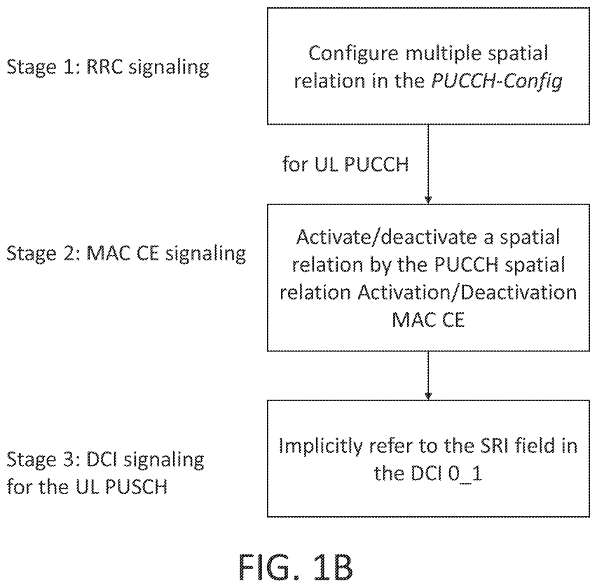

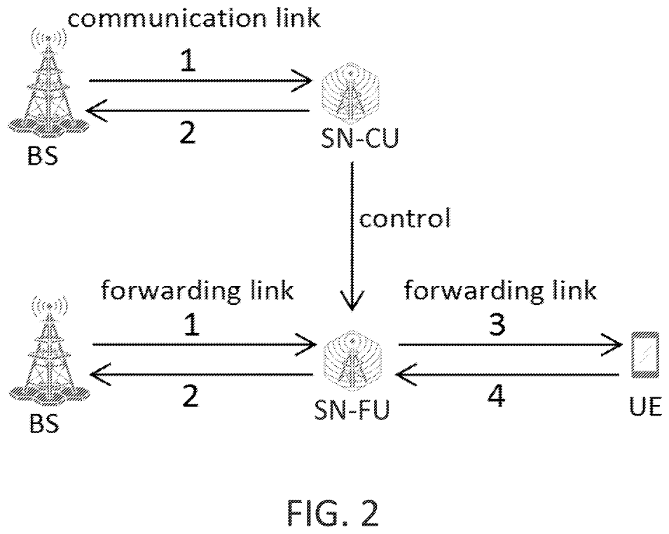

FIG. 1A shows a schematic diagram of a downlink beam indication mechanism according to an embodiment of the present disclosure. The diagram of FIG. 1A comprises three stages:

Stage 1—RRC signaling: configure multiple TCI states in the PDSCH-Config and, for DL PDCCH, choose TCI states from the PDSCH-Config and reconfigure in the PDCCH-Config;

Stage 2—MAC CE signaling: for DL PDSCH, activate/deactivate one or more TCI states by the UE-specific PDSCH MAC CE, and, for DL PDCCH, select a TCI state directly by the UE-specific PDCCH MAC CE; and

Stage 3—DCI signaling (for DL PDSCH): select a TCI state by the TCI field in the DCI 1_1.

FIG. 1B shows a schematic diagram of an uplink beam indication mechanism according to an embodiment of the present disclosure. The diagram of FIG. 1B comprises three stages:

Stage 1—RRC signaling: configure multiple spatial relation in the PUCCH-Config;

Stage 2—MAC CE signaling: for UL PUCCH, activate/deactivate a spatial relation by the PUCCH spatial relation Activation/Deactivation MAC CE; and

Stage 3—DCI signaling (for the UL PUSCH): implicitly refers to the SRI field in the DCI 0_1.

In an embodiment, a unified TCI framework for DL and UL beam indication can be implemented. In the unified TCI framework, there is a common TCI state pool for unified TCI state(s) for both DL and UL. The data and control transmission/reception for DL and UL can be separately indicated by the independent TCI states with different signaling, or jointly indicated by a common TCI state with a single signaling. In that case, the DCI-based signaling update of TCI state can also be considered in the unified TCI framework.

In an embodiment, a Smart Node (SN) is generally located in a selected position with good wireless channel condition (e.g., with LOS path) to the BS. When the SN starts up, a network integration procedure is carried out. Via this network integration procedure, the BS identifies the SN as a network node and configures the SN for its following amplify-and-forward operation. After the completion of integration, the SN carries out amplify-and-forward operation for UEs in its coverage with the control information received from the BS.

In this disclosure, the SN includes two functional parts: one is the communication unit (CU) and the other is the forwarding unit (FU). The CU includes and is not limited to a mobile terminal or a device with part of UE function. The FU includes and is not limited to a radio unit of a BS or a RIS (Reconfigurable Intelligent Surface).

In this disclosure, a communication link is the link between the BS and the SN-CU is called the communication link. The index 1 and 2 indicates DL and UL directions, respectively. Using the communication link, the SN-CU acts like a UE to carry out initial access, measurements and reception of control information. The control information for the SN-FU is also received by the SN-CU from the BS via the communication link.

In this disclosure, a forwarding link is the forwarding link used between the BS and the SN-FU, and between the SN-FU and the UE. Similarly, the indexes 1-4 are used to indicate directions. The SN-FU carries out intelligent amplify-and-forward operation using the control information received by the SN-CU from the BS.

In an embodiment, for the communication link, the beam management procedure between the BS and the SN-CU can reuse the current NR specification. In particular, considering that the communication condition of communication link is almost stable, some simplified beam indication methods can be considered.

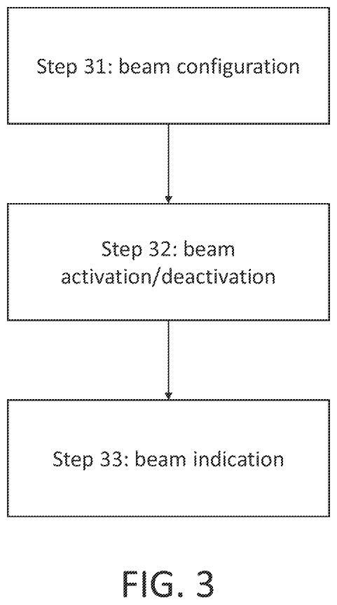

In an embodiment, for the forwarding link, the beam management procedure needs to be defined. Since the SN-FU carries out simultaneous reception from the BS/UEs and transmission to the UEs/BS, the SN-FU's beams used in both reception and transmission should be indicated by the BS. To save signaling cost and reduce delay in forwarding operation, the following procedure can be used, as shown in FIG. 3.

FIG. 3 illustrates a method for beam management procedure according to an embodiment of the present disclosure. Specifically, the procedure shown in FIG. 3 comprises:

Step 31: beam configuration. For example, the RRC configuration for SN-CU and SN-FU can be independent or unified. For example, the RRC configuration for SN-FU can be a separate configuration for the DL and UL, or unified TCI framework applied both for the DL and UL.

Step 32: beam activation/deactivation. For example, the additional MAC CE to activate/deactivate the corresponding RRC configuration. For example, reuse the legacy MAC CE to activate/deactivate with a new defined parameter.

Step 33: beam indication. For example, extra MAC CE indication for beam indication. For example, the new DCI indication, or reuse the legacy DCI indication with a new defined parameter.

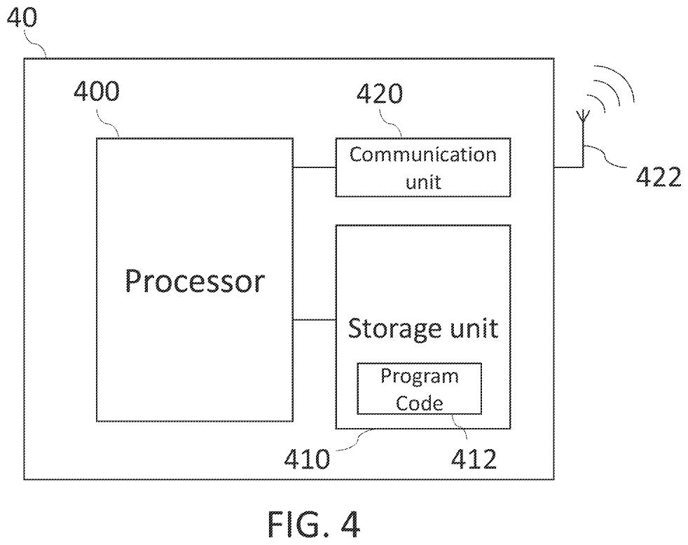

FIG. 4 relates to a schematic diagram of a wireless terminal 40 according to an embodiment of the present disclosure. The wireless terminal 40 may be a user equipment (UE), a mobile phone, a laptop, a tablet computer, an electronic book or a portable computer system and is not limited herein. The wireless terminal 40 may include a processor 400 such as a microprocessor or Application Specific Integrated Circuit (ASIC), a storage unit 410 and a communication unit 420. The storage unit 410 may be any data storage device that stores a program code 412, which is accessed and executed by the processor 400. Embodiments of the storage unit 412 include but are not limited to a subscriber identity module (SIM), read-only memory (ROM), flash memory, random-access memory (RAM), hard-disk, and optical data storage device. The communication unit 420 may a transceiver and is used to transmit and receive signals (e.g. messages or packets) according to processing results of the processor 400. In an embodiment, the communication unit 420 transmits and receives the signals via at least one antenna 422 shown in FIG. 4.

In an embodiment, the storage unit 410 and the program code 412 may be omitted and the processor 400 may include a storage unit with stored program code.

The processor 400 may implement any one of the steps in exemplified embodiments on the wireless terminal 40, e.g., by executing the program code 412.

The communication unit 420 may be a transceiver. The communication unit 420 may as an alternative or in addition be combining a transmitting unit and a receiving unit configured to transmit and to receive, respectively, signals to and from a wireless network node (e.g., a base station).

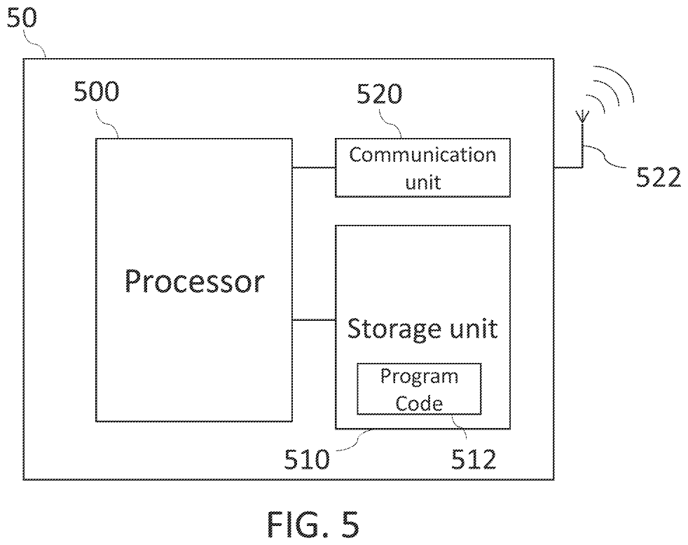

FIG. 5 relates to a schematic diagram of a wireless network node 50 according to an embodiment of the present disclosure. The wireless network node 50 may be a satellite, a base station (BS), a smart node, a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 50 may comprise (perform) at least one network function such as an access and mobility management function (AMF), a session management function (SMF), a user place function (UPF), a policy control function (PCF), an application function (AF), etc. The wireless network node 50 may include a processor 500 such as a microprocessor or ASIC, a storage unit 510 and a communication unit 520. The storage unit 510 may be any data storage device that stores a program code 512, which is accessed and executed by the processor 500. Examples of the storage unit 512 include but are not limited to a SIM, ROM, flash memory, RAM, hard-disk, and optical data storage device. The communication unit 520 may be a transceiver and is used to transmit and receive signals (e.g. messages or packets) according to processing results of the processor 600. In an example, the communication unit 520 transmits and receives the signals via at least one antenna 522 shown in FIG. 5.

In an embodiment, the storage unit 510 and the program code 512 may be omitted. The processor 500 may include a storage unit with stored program code.

The processor 500 may implement any steps described in exemplified embodiments on the wireless network node 50, e.g., via executing the program code 512.

The communication unit 520 may be a transceiver. The communication unit 520 may as an alternative or in addition be combining a transmitting unit and a receiving unit configured to transmit and to receive, respectively, signals to and from a wireless terminal (e.g., a user equipment or another wireless network node).

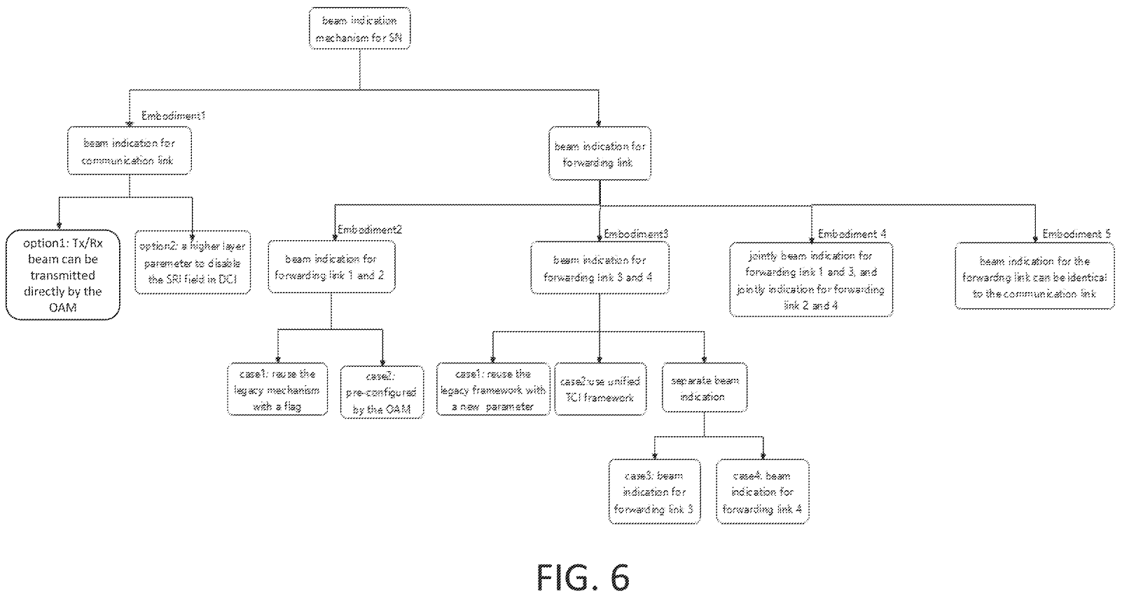

Some aspects of the proposed methods in this disclosure are organized in FIG. 6. FIG. 6 shows a tree diagram according to embodiments of the present disclosure.

### Embodiment 1—Direct Beam Indication Transmission

In embodiment 1, since the location of SN does not change frequently, the communication condition of BS-SN link can be treated as almost stable, which means it is not necessary to update the beam frequently. As such, a simplified beam indication method can be considered for the communication links 1 and 2, including the following options.
a. Option 1: the Tx/Rx beam for the communication link between BS and SN-CU can be transmitted directly by the OAM.

In detail, the Tx/Rx beam information for the communication link between BS and SN-CU can be transmitted by the OAM. In the current specification, the beam information is implicitly indicated by a complicated structure (i.e., the RRC-MAC-DCI structure). However, the communication condition of BS-SN link is almost stable, there is no need to update the beam frequently. In this case, the OAM can directly transmit the Tx/Rx beam for the DL/UL communication link between BS and SN to the SN-CU. The Tx and Rx beam of SN-CU for the communication link should be known by the BS. This can be reported by the SN after finishing the integration progress, or can be directly configured by the OAM.

Option 2: the Tx/Rx beam for the communication link between BS and SN-CU can be pre-configured in the SN-CU by the OAM and indicated via DCI.

In this case, the Tx/Rx beam for the communication link between BS and SN-CU can be pre-configured in the SN-CU by the OAM. The OAM can directly pre-configure the TCI state list for the communication link into the SN. And the selected TCI state used for the communication link can be indicated by the TCI field in DCI.

### Beam Indication of Forwarding Link

In embodiment 1, for the beam indication of forwarding link, the forwarding link can be divided from three angles and have the following beam indication methods:
1) the beam indication mechanisms for the forwarding links 1 and 2;
2) the beam indication mechanisms for the forwarding links 3 and 4; and
3) the beam information for forwarding link 1 and 3 can be jointly indicated, and similarly the beam information for forwarding link 2 and 4 can be jointly indicated.

### Embodiment 2—Beam Indication for the Forwarding Links 1 and 2

In embodiment 2, the beam indication for the forwarding links 1 and 2 includes two parts: the Rx beam of SN-FU to receive the forwarding information from the BS, and the Tx beam of SN-FU to transmit the UE's signal to the BS. Thus, the BS needs to indicate the Rx beam and the Tx beam to the SN-CU, and the SN-CU can control the SN-FU to carry out the forwarding operation. The following cases can be considered:

Case 1) The legacy beam indication mechanism with refinements can be considered for the forwarding links 1 and 2.

Considering that the reference signal (RS) for the communication link and forwarding links 1 and 2 are the same, the legacy RRC configuration of TCI state and spatial relation can be reused for the forwarding links 1 and 2. The beam indication methods has the following options:

Option 1: the legacy MAC CE command can be reused to activate or select the TCI state and spatial relation, and a new higher layer parameter is defined to indicate this activated/selected TCI state or spatial relation is for the forwarding links 1 and 2.

Option 2: the legacy field in DCI can be reused: the TCI field in DCI 1_1 and the SRI field in DCI 0_1 can be reused. And a new higher layer parameter can be defined to indicate the TCI field and SRI field in DCI is for the forwarding links 1 and 2. If the new higher layer parameter has not been configured, these two fields are for the communication link between BS and SN-CU.

Option 3: a new field can be defined in the DCI to indicate the beam information for the forwarding links 1 and 2. For example, a new field” TCI for forwarding” can be defined in the DCI 1_1 and a new field “SRI for forwarding” can be defined in the DCI 0_1 to separately indicate the beam information for the forwarding links 1 and 2.

Case 2) The beam information of the forwarding links 1 and 2 can be directly indicated by the OAM.

Option 1: the beam information of the forwarding link 1 and 2 can be directly transmitted by the OAM.

Considering that the location of SN and BS is almost fixed, the beam information for the forwarding links 1 and 2 can be directly transmitted by the OAM. Then the SN-CU can control the SN-FU to use the corresponding beam to transmit/receive the forwarding information from the BS/UE. The Tx and Rx beam of SN-FU for the forwarding links 1 and 2 should be known by the BS. This can be reported by the SN-CU after finishing the integration progress, or can be directly configured by the OAM.

Option 2: the Tx/Rx beam for the forwarding links 1 and 2 between BS and SN-FU can be pre-configured by the OAM and indicated via DCI.

In this case, the Tx/Rx beam for the forwarding links 1 and 2 can be pre-configured in the SN-CU by the OAM. The OAM can directly pre-configure the TCI state list for the forwarding link 1 and 2 link into the SN. And the selected TCI state used for the forwarding links 1 and 2 can be indicated by the TCI field in DCI.

Similarly, the two options above can be applicable to the forwarding links 3 and 4.

### Embodiment 3—the Beam Indication for the Forwarding Links 3 and 4

In embodiment 3, the beam indication for the forwarding links 3 and 4 includes the Tx beam of SN-FU to forward the DL signal from BS to UE and the Rx beam of SN-FU to receive the UL signal from UE. In some approaches, the beam indication mechanism includes two mechanisms: (a) the separate beam indication for DL and UL, and (b) the unified TCI framework applied for both DL and UL.

As such, for the beam indication for the forwarding links 3 and 4, the beam indication framework in the current specification can be reused. The following cases can be considered.

Case 1) A higher layer parameter can be defined to indicate the legacy beam indication mechanism for DL and UL can be reused for the forwarding links 3 and 4.

Considering that the communication links 1 and 2 between the BS and SN-CU is almost stable, the UL transmission beam of SN-CU can reuse beam information when the SN-CU transmits the PRACH to the BS, and the DL reception beam of SN-CU can reuse the beam for receiving the SSB from BS. Or the beam information of communication link can use the pre-configured information, e.g., the method in embodiment 1. In this case, the total framework of beam indication for the communication link can be directly reused by the forwarding links 3 and 4, and a flag can be defined to indicate the legacy beam indication mechanism for DL and UL can be reused for the forwarding links 3 and 4. To be specific, the Tx beam of forwarding link 3 can reuse the legacy DL beam indication mechanism, the Rx beam of forwarding link 4 can reuse the UL beam indication mechanism. If this new higher layer parameter is not configured, the TCI state and spatial relation is used for the communication link as legacy. And this case can also applicable to the forwarding links 1 and 2.

Case 2) The unified TCI framework for the forwarding links 3 and 4 can be considered.

The unified TCI framework means the downlink and uplink beam information can be both indicated by the TCI state. In this case, the forwarding links 3 and 4 can be taken as an example to demonstrate the method of using the unified TCI state to indicate the beam information, and this method can also be applicable to the forwarding links 1 and 2. The beam indication procedure of unified TCI framework includes three steps: RRC signaling to configure the unified TCI state, MAC CE signaling to activate or select unified TCI states, and the DCI signaling to select or update the unified TCI state. The information of TCI state can be different reference signal for QCL type, or different TCI (e.g., index of TCI state used in the legacy specification). For the forwarding links 3 and 4, each step mentioned above can have different signaling options listed below.

### (1) RRC Signaling to Configure Unified TCI States for the Forwarding Links 3 and 4

Additional RRC configuration of unified TCI states can be configured for both the forwarding link 3 and link 4 between the SN-FU and UEs. The transmission beam of SN-FU for the forwarding link 3 and the reception beam of SN-FU for the forwarding link 4 can both be implicitly indicated by the QCL information of TCI state. The BS should indicate this additional RRC configuration of unified TCI state to the SN-CU, then the specific TCI state for the DL and UL can be activated or selected by the MAC CE signaling or DCI signaling.

There are two options to configure the unified TCI states for at least one of the forwarding links 3 and 4:
a. Option 1: a new TCI state field (e.g., named Unified-tci-States-SN-ToAddModList), is added in SN-CU's high parameter PDSCH-Config for SN-FU. The field is only applicable for an SN, which is absent for a UE. To be specific, the SN-FU can be configured by the BS with a list of up to L unified-TCI-State-SN configurations. The list of unified-TCI-State-SN configurations can be included in the higher layer parameter PDSCH-Config for the SN-CU. The value L depends on the SN-FU capability maxNumberConfiguredUnifiedTClstatesSN.
b. Option 2: the current unified TCI state field is shared by both SN-CU and SN-FU, which is divided into two parts. The first part with up to L1 unified TCI states configurations for at least one of the communication links 1 and 2, where L1 depends on the SN-FU capability maxL1, which means the max number of beams (or spatial filters) that the SN-FU can support on the corresponding communication link. The second part with up to L2 unified TCI states configurations for at least one of the four forwarding links, where L2 depends on the SN-FU capability maxL2. If maxL1 and maxL2 is preconfigured by BS or OAM, these two fields are optional. For example, the first part is used to configure the communication link 1 and 2, and the second part can be used to configure the forwarding links 3 and 4.

Option 3: The new unified TCI state field is defined for the SN-FU, which is divided into two parts. The first part with up to Y1 unified TCI states configurations for at least one of the four forwarding links, where Y1 depends on the SN-FU capability maxY1, which means the max number of beams (or spatial filters) that the SN-FU can support on the corresponding forwarding link. The second part with up to Y2 unified TCI states configurations for at least one of the forwarding links, where Y2 depends on the SN-FU capability maxY2. If maxY1 and maxY2 is preconfigured by BS or OAM, these two fields are optional. For example, the first part is used to configure the forwarding link 1 and 2, and the second part can be used to configure the forwarding links 3 and 4.

### (2) MAC CE Signaling to Activate/Deactivate or Select a Unified TCI State for the Forwarding Links 3 and 4.

In some embodiments, the beam information can use different unified TCI states for each link or only use a common unified TCI state for different link combination.

Option 1: an additional MAC CE command can be defined to select one or more unified TCI states only applicable for one link. In this case, the forwarding links 3 and 4 use the different MAC CE command to select one or more unified TCI states.

Option 2: considering that the unified TCI state configuration can be divided into two parts, an additional MAC CE command can be defined to select one or more unified TCI states, which can be applicable for the combination of different links. For example, an additional MAC CE command is defined to select one or more unified TCI states applicable for both the forwarding links 3 and 4. Similarly, for other link combination, an additional MAC CE command can be defined to select one or more unified TCI state applicable for at least one of links, e.g., the commination links 1 and 2 and the forwarding links 1 and 2, or the communication link 2 and forwarding link 2, or the forwarding link 3 and forwarding link 1, or the communication link 1 and forwarding link 3, etc.

Option 3: considering that the unified TCI states can be divided into two parts, and each part configured information for different links, additional MAC CE command can be defined to select one or more unified TCI states for each part. For example, the unified TCI states comprises two parts, the first part configures information for the communication links 1 and 2, and the second part configures information for the forwarding links 3 and 4. in this case, two different MAC CE command can be defined to select one or more unified TCI states for each part, which means one MAC CE command can be defined to select the unified TCI states for the communication links 1 and 2, and another MAC CE command can be defined to select the unified TCI states for the forwarding links 3 and 4.

Option 4: a new higher layer parameter can be defined to indicate the one or more TCI states selected by the legacy MAC CE command (i.e., PUCCH spatial relation Activation/Deactivation MAC CE, or TCI State Indication for UE-specific PDCCH MAC CE or TCI States Activation/Deactivation for UE-specific PDSCH MAC CE, etc.) is used for at least one of the forwarding links. For example, a new higher layer parameter can be defined to indicate that the legacy TCI State Indication for UE-specific PDCCH MAC CE can be used for the forwarding links 3 and 4.

### (3) DCI Signaling to Select a Unified TCI State

The DCI signaling can be used to select one of the unified TCI states selected by MAC CE command for the forwarding links. In this case, we take the forwarding links 3 and 4 as an example. If the forwarding links 3 and 4 use different unified TCI state, the options for beam indication of DL forwarding link 3 are explained later. For the beam indication of UL forwarding link 4, there are the following options.

Option 1: a new DCI can be defined to select the unified TCI state, there are the following options:
a) The BS configures an extra RNTI for the SN-FU in addition to the SN-CU's RNTI. Then the SN-CU monitors the PDCCH with both RNTIs. If a DCI is scrambled by the SN-CU's RNTI, the SN-CU carried out communication with the BS like a UE with assigned time-frequency resource, MCS and other control parameters. If a DCI is scrambled by the SN-FU's RNTI, the SN-CU decodes the DCI for the SN-FU and controls the SN-FU's amplify-and-forward operation accordingly. In some embodiments, different RNTIs can be defined for the DCI used for different links.
b) the BS configured an extra RNTI for the SN-CU to scramble the information for the communication link, if a DCI is scrambled by this extra RNTI, then the SN-CU carried out communication with the BS like a UE with assigned time-frequency resource, MCS and other control parameters. If a DCI is scrambled by the legacy RNTI, the SN-CU decodes the new DCI format for the SN-FU and controls the SN-FU's amplify-and-forward operation accordingly.
c) A new DCI format number (e.g., named sn_3) is defined. And the DCI is scrambled using the SN-CU's RNTI configured for the forwarding link. When the SN-CU receives a DCI, it checks the DCI format to determine whether the DCI is for SN-CU or SN-FU. This new DCI format can comprise different unified TCI state for one or more of different forwarding links. For example, this new DCI format can be used to select the unified TCI states for the forwarding link 3 and forwarding link 4, respectively.

Option 2: a new field in DCI can be defined to indicate that the selected unified TCI state index is for at least one of the forwarding link. For example, a new “unified TCI field” can be defined in DCI 1_1 to indicate the unified TCI state index for the forwarding link 3. similarly, this new field can also be defined to indicate the beam information for both the forwarding links 3 and 4, or forwarding links 1 and 2, etc.

Option 3: the beam indication field in the DCI (e.g., the TCI field or the SRI field) can be reused, and a new higher layer parameter can be defined to indicate that this field is used to select a unified TCI state index applicable for at least one of the forwarding links. For example, the “TCI field” in DCI 1_1 can be used to indicate the unified TCI state index for the forwarding links 3 and 4. similarly, this field can also be used to indicate the unified TCI state for the forwarding links 3 and 4, or forwarding link 1, etc.

The separate beam indication method for each link in legacy approaches can be considered for the links including the two communication links and the four forwarding links, which means a separate TCI state can be configured for each link. In this case, we take the forwarding link 3 as an example, and the method and options below can also applicable for other links.

Case 3) The TCI indication mechanism can be considered only for the forwarding link 3.

The legacy beam indication for DL in some approaches uses the TCI state to implicitly indicate the beam information. In this case, the separate TCI state list can be configured for each link, including the two communication links and the four forwarding links. Here, we take the forwarding link 3 as an example. Similarly, there are three steps including the RRC signaling, the MAC CE signaling and the DCI signaling in the beam indication procedure for DL. As such, the following options in each step can be considered.

### (1) RRC Signaling: The BS Configures a Non-Physical Channel Related TCI List for the Forwarding Link 3

In current NR specifications, the TCI configuration is applied for a specific physical channel. On the DL forwarding link 3, however, the SN-FU transparently forwards the received signal from the BS to the UE, and there is no physical channel conception in this amplify-and-forward operation. Therefore, a non-physical channel related TCI list should be defined for the SN-FU. The information of TCI state can be different reference signal for QCL type, or different TCI (e.g., index of TCI state used in the legacy specification). To be more specific, the SN-FU can be configured by the BS with a list of up to M TCI-State-SN configurations. The list of TCI-State-SN configurations can be included in the higher layer parameter PDSCH-Config for the SN-CU. There are two options.

Option 1: a new TCI state field (e.g., named tci-States-SN-ToAddModList), is added to indicate the TCI state configuration only applicable for the forwarding link 3 in SN-CU's high parameter PDSCH-Config for SN-FU. The field is only applicable for an SN, which is absent for a UE. The value M depends on the SN-FU capability maxNumberConfiguredTClstates3.
a. Option 2: the current TCI state field is shared by both SN-CU and SN-FU, which is divided into two sets. The first set with up to M1 TCI-State-SN configurations for the communication link 1, where M1 depends on the SN-FU capability maxNumberConfiguredTCIstates1, which means the max number of beams (or spatial filters) that the SN-FU can support on the communication link 1. The second set with up to M2 TCI-State configurations for the forwarding link 3, where M2 depends on the SN-FU capability maxNumberConfiguredTClstates3. If maxM1 and maxM2 is preconfigured by BS or OAM, these two fields are optional.

Option 3: a new TCI state field can be configured for SN-FU, which is divided into multiple sets. Each set defined in this new defined TCI state field can be used for one of the six link, including two communication links and four forwarding links. For example, this TCI state field is divided into 4 sets, this 4 sets are configured for the forwarding link 1, 2, 3 and 4, respectively.

### (2) MAC CE Signaling to Activate/Deactivate or Directly Select TCI State for Forwarding Link 3

In the current specification, the MAC CE command can be used to activate or select the TCI state configured in RRC. For the forwarding link 3, the RRC configuration of TCI states has the following options: reuse the legacy TCI configuration legacy approaches; use the unified TCI configuration as in step (1) of case 2; or use the TCI configuration in the indication mechanism only for the forwarding link 3 as in step (1) of case 3.

In the embodiment, based on the RRC configuration, the following options to activate/select TCI state for the forwarding link 3 are provided:

Option 1: considering the dynamical beam indication method, an additional MAC CE command can be defined to select one or more TCI states for the forwarding link 3. Then the DCI can be used to select the specific TCI state. In this case, this MAC CE command can have different constructions including:

A) this MAC CE command is used to select one or more TCI state only for forwarding link 3. in generally, the MAC CE command is designed to select one or more TCI states only for one link.

B) this MAC CE command is used to select one or more TCI states for different links, for example, it is used to select one or more TCI states for the communication link 1 and forwarding link 1.

Option 2: the legacy MAC CE command can be reused (i.e. TCI State Indication for UE-specific PDCCH MAC CE or TCI States Activation/Deactivation for UE-specific PDSCH MAC CE) to select or activate TCI state only for the forwarding link 3. A new higher layer parameter is defined to indicate this is for the forwarding link 3. When this new higher layer parameter has not been configured, this MAC CE command is used as for the communication link between BS and SN-CU.

### (3) DCI Signaling to Select a TCI State for the Forwarding Link 3

After configured TCI states by RRC and selected TCI states by the MAC CE command, the DCI can be used to select one TCI state for the forwarding link 3. This can be done with the following options.

Option 1: after the SN is connected to a BS, the BS can use a new DCI format to indicate the beam the forwarding link 3. To identify this new DCI, there are the following options:
a) The BS configures an extra RNTI for the SN-FU in addition to the SN-CU's RNTI. Then the SN-CU monitors the PDCCH with both RNTIs. If a DCI is scrambled by the SN-CU's RNTI, the SN-CU carried out communication with the BS like a UE with assigned time-frequency resource, MCS and other control parameters. If a DCI is scrambled by the SN-FU's RNTI, the SN-CU decodes the new DCI format for the SN-FU and controls the SN-FU's amplify-and-forward operation accordingly. In some embodiments, different RNTIs can be defined for the DCI used for different links.
b) the BS configured an extra RNTI for the SN-CU to scramble the information for the communication link, if a DCI is scrambled by this extra RNTI, then the SN-CU carried out communication with the BS like a UE with assigned time-frequency resource, MCS and other control parameters. If a DCI is scrambled by the legacy RNTI, the SN-CU decodes the new DCI format for the SN-FU and controls the SN-FU's amplify-and-forward operation accordingly.
c) A new DCI format number (e.g., named sn_3) is defined. And the DCI is scrambled using the SN-CU's RNTI configured for the forwarding link. When the SN-CU receives a DCI, it checks the DCI format to determine whether the DCI is for SN-CU or SN-FU. This new DCI format can comprise different TCI state for one or more of different forwarding links. For example, this new DCI format can be used to select the TCI states for the forwarding link 3 and forwarding link 1, respectively.

Option 2: the TCI field in DCI 1_1 can be reused, and a new higher layer parameter is defined to indicate this field is for the forwarding link 3. If the new higher layer parameter has not been configured, this field is used for the communication link.

Option 3: a new field can be added in the DCI 1_1 to indicate the selected TCI state index for the forwarding link 3, e.g., the “Transmission configuration indication for SN” field can be defined, and this field is only applicable for SN, which is absent for normal UEs.

Case 4) The beam indication by the spatial relation mechanism can be considered for the forwarding link 4.

In some embodiments, the UL beam indication is implicitly indicated by spatial relation, and also includes 3 steps including the RRC signaling, the MAC CE signaling and the DCI signaling. As such, this mechanism can be reused for forwarding link 4, and following options for each step can be considered:

### (1) RRC Signaling to Configure Spatial Relation List for the Forwarding Link 4

An additional RRC signaling of spatial relation only for the forwarding link 4 can be configured and indicated to the SN-CU. This additional RRC configuration of spatial relation can be used to implicitly indicate the Rx beam of SN-FU when receiving information from UEs. To be more specific, the SN-FU can be configured by the BS with a list of up to N SpatialRelationInfo-SN configurations. The list of SpatialRelationlnfo-SN configurations can be included in the higher layer parameter PUCCH-Config for the SN-CU, the field is only applicable for an SN, which is absent for a UE. The value N depends on the SN-FU capability maxNrofSpatialRelationSNInfos:

### (2) MAC CE Signaling to Activate/Select a Spatial Relation for the Forwarding Link 4

In the current specification, the MAC CE command can be used to select the spatial information configured in RRC, there are the following options to select a spatial relation for the forwarding link 4:

Option 1: Considering the dynamical beam indication method, an additional MAC CE command can be defined to activate the spatial information for the forwarding link 4. Then the DCI can be used to select the specific spatial information.

Option 2: Considering the semi-static beam indication method, an additional MAC CE command can be defined to directly select a specific spatial relation for the forwarding link 4.

Option 3: Reuse the legacy MAC CE command (i.e., PUCCH spatial relation Activation/Deactivation MAC CE) to select the spatial relation for the forwarding link 4. In this case, the spatial relation ID in the MAC CE command corresponding to the spatial relation. And a new higher layer parameter is defined to indicate this is for the forwarding link 4. If this new higher layer parameter has not been configured, this MAC CE command is used as for the communication link.

### (3) DCI Signaling to Select a Spatial Relation for the Forwarding Link 4

The DCI can be used to select the spatial information for the forwarding link 4, and there are the following options:

Option 1: the BS can use a new DCI format to indicate the beam used on the forwarding link 4. This new DCI is identified in the same way proposed in the option 1 of (3) in case 3. The new DCI format for the SN-FU includes the following content:

time-frequency resource indication: this field indicates the time-frequency resource to be forwarded by the SN-FU. The time and the frequency resource indication can be separately indicated by reusing current DCI format fields “Time domain resource assignment” and “Frequency domain resource assignment” in the NR specifications; and

the beam spatial parameter: This field indicates the beams to be used in the SN-FU's forwarding link 4. To be specific, the “spatial relation indicator” can be defined in this new DCI format, and can be used to indicate the spatial relation between the RS and the Rx beam of SN-FU for the forwarding link 4.

Option 2: Reuse the SRI field in DCI 0_1, and a new higher layer parameter is defined to indicate this field is for the forwarding link 4. This SRI field can be used to indicate the selected spatial relation ID. If the new higher layer parameter has not been configured, this field is used as legacy.

Option 3: A new field can be defined in the DCI 0_1 to indicate the spatial relation for the forwarding link 4, e.g., the “spatial relation indication for SN” field can be added in the DCI 0_1 to indicate the selected spatial relation ID, and this field is only applicable for SN, which is absent for normal UEs.

### Embodiment 4—Jointly Beam Indication for the Forwarding Link 1 and 3, and Jointly Beam Indication for the Forwarding Link 2 and 4

The SN-FU can carry out simultaneous reception from the BS/UEs and transmission to the UEs/BS. In this case, the Rx beam for forwarding link 1 and the Tx beam for forwarding link 3 can be jointly indicated, the Tx beam for forwarding link 2 and the Rx beam for forwarding link 4 can be jointly indicated. If the implicit beam indication mechanisms in the current specification are considered, the RS used to provide reference beam for forwarding links 1 and 2 should be the same as the RS for the communication link. In this case, the RRC configuration of TCI states and spatial relation can share a common configuration with the communication link.

New DCI formats, e.g., named format 0_3 and 1_3, can be defined for SN-FU. The content of the new DCI formats is less than the current DCI formats, since the SN-FU only amplify-and-forwards without data decoding. The new DCIs are scrambled with the SN-CU's RNTI. When the SN-CU correctly receives a DCI, the SN-CU checks the DCI format to determine whether it is for the SN-CU or for the SN-FU. The content of the new DCI formats includes:

time-frequency resource indication: this field indicates the time-frequency resource to be forwarded by the SN-FU. The time and the frequency resource indication can be separately indicated by reusing current DCI format fields “Time domain resource assignment” and “Frequency domain resource assignment” in the NR specifications; and

the beam spatial parameter: this field indicates the beams to be used in the SN-FU's forwarding operation. Since the SN-FU needs to maintain beams on two links (i.e., the BS-SN link and the SN-UE link) simultaneously, two beam spatial indicators are needed for the two links, respectively.

For the amplify-and-forward direction BS-SN-UE, the new DCI format 1_3 can be used:
a. The beam indicator ID1 corresponds to the BS-SN forwarding link 1, in which a DL reference signal index (e.g., SSB index or CSI-RS index) with QCL type D (i.e., with the same spatial characteristics) indicates the reception beam to be used by the SN-FU to receive the coming DL signal carried by the BS-SN link. A flag can be defined to enable this beam indicator ID1 field. For example, the beam indicator ID1 can be a TCI state index.
b. The beam indicator ID2 corresponds to the SN-UE forwarding link 3, in which a reference signal index (e.g., SSB index or CSI-RS index) indicates the transmission beam to be used by the SN-FU to forward the coming DL signal carried by the BS-SN link. The reference signal index is included in the beam-split RS group. In this way, the BS can control the SN-FU to forward DL signal with a UE-specific beamforming on the SN-UE link. For example, the beam indicator ID2 can be a TCI state index.

For the amplify-and-forward direction UE-SN-BS, the new DCI format 0_3 can be used:
a. The beam indicator ID1 corresponds to the SN-BS forwarding link 2, in which a UL reference signal index (e.g., SRS resource indicator) indicates the transmission beam to be used by the SN-FU to forward the coming UL signal carried by the UE-SN link. For example, the beam indicator ID1 can be a TCI state or spatial relation index.
b. The beam indicator ID2 corresponds to the UE-SN forwarding link 4, in which a reference signal index (e.g., SSB index or CSI-RS index) indicates the reception beam to be used by the SN-FU to receive the coming UL signal carried by the UE-SN link. The reference signal index is included in the beam-split RS group. For example, the beam indicator ID2 can be a TCI state or spatial relation index.

### Embodiment 5: Beam Indication for the Forwarding Link 1 and 2 can Follow the Beam Indication for the Communication 1 and 2

Considering that the locations of SN and BS do not change frequently, the beam information or indication for the forwarding link between the SN-FU and BS can use the same beam information or indication for the communication link between the SN-CU and the BS. For example, the beam information or indication for the forwarding link 1 can follow the same beam information or indication for the communication link 1, and the beam information or indication for the forwarding link 2 can follow the same beam information or indication for the communication link 2.

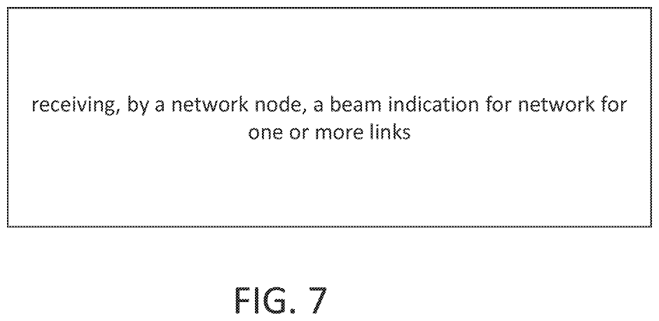

FIG. 7 shows a flowchart of a method according to an embodiment of the present disclosure. The method shown in FIG. 7 may be used in a SN and comprises: receiving, by a network node, a beam indication for a network for one or more links. The links comprises at least one of: a first communication link from a wireless communication node to the network node; a second communication link from the network node to the wireless communication node; a first forwarding link from the wireless communication node to the network node; a second forwarding link from the network node to the wireless communication node; a third forwarding link from the network node to a user equipment, UE; or a fourth forwarding link from the user equipment to the network node.

Details of the method can be ascertained with reference to the embodiments described above.

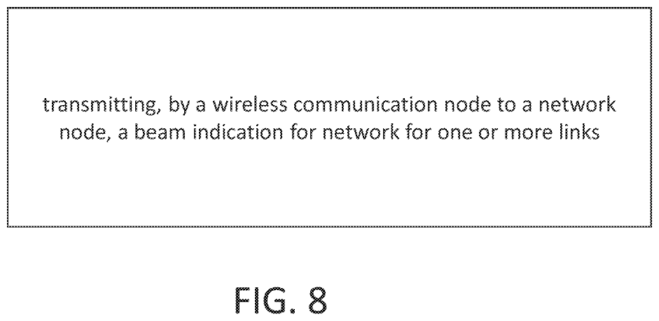

FIG. 8 shows a flowchart of another method according to an embodiment of the present disclosure. The method shown in FIG. 8 may be used in a BS and comprises: transmitting, by a wireless communication node to a network node, a beam indication for a network for one or more links. The links comprises at least one of: a first communication link from a wireless communication node to the network node; a second communication link from the network node to the wireless communication node; a first forwarding link from the wireless communication node to the network node; a second forwarding link from the network node to the wireless communication node; a third forwarding link from the network node to a user equipment, UE; or a fourth forwarding link from the user equipment to the network node.

Details of the method can be ascertained with reference to the embodiments described above.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method comprising:
receiving, by a network node, a beam indication for a network for one or more links comprising at least one of:
a first communication link from a wireless communication node to the network node;
a second communication link from the network node to the wireless communication node;
a first forwarding link from the wireless communication node to the network node;
a second forwarding link from the network node to the wireless communication node;
a third forwarding link from the network node to a user equipment (UE); or
a fourth forwarding link from the user equipment to the network node.

2. The wireless communication method of claim 1, wherein the beam indication for the links are determined by a Transmission Configuration Indicator (TCI).

3. The wireless communication of claim 2, wherein a first type TCI is associated to each of the links;
wherein a downlink control information (DCI) for indicating a TCI state is scrambled by using a first Radio Network Temporary Identifier (RNTI), and the first RNTI is different from a second RNTI for scrambling DCI corresponding to a communication unit of the network node;
wherein the DCI for indicating the TCI state for the at least one of communication link is scrambled by using a first RNTI, and the first RNTI is different from a second RNTI for scrambling DCI for indicating the TCI state for the at least one of forwarding link;
wherein the DCI for indicating the TCI state has a first DCI format, and the first DCI format is different from a second DCI format DCI corresponding to a communication unit of the network node;
wherein the DCI for indicating the TCI state in the first DCI format comprises one or more TCIs for one or more of the first, second, third and fourth forwarding links respectively; and
a higher layer parameter is used to indicate that the indication of beam information via DCI is enabled.

4. The wireless communication of claim 2, wherein a second type TCI is associated to the one or more links;
wherein each of second type TCI state comprises a first part and a second part, the first part configures information for at least one of the first or second communication link, and a second part configures information for at least one of the first, second, third or fourth forwarding link; and
wherein each of second type TCI state comprises a first part and a second part, the first part configures information for at least one of the first, second, third or fourth forwarding link, and a second part configures information for at least one of the first, second, third or fourth forwarding link.

5. The wireless communication method of claim 2, wherein all or partially signal of beam indication is transmitted by an Operations Administration and Maintenance (OAM) from network to the network node; and wherein the indicated TCI state via DCI is configured by the OAM.

6. The wireless communication method of claim 2, wherein TCI states are configured by Radio Resource Control (RRC) signaling;
wherein each of second type TCI state comprises a first part and a second part, the first part configures information for at least one of the first or second communication link, and a second part configures information for at least one of the first, second, third or fourth forwarding link;
wherein each of second type TCI state configuration comprises a first part and a second part, the first part configures information for at least one of the first, second, third or fourth forwarding link, and a second part configures information for at least one of the first, second, third or fourth forwarding link;
wherein one or multiple of the first type TCI states for different link is selected by corresponding medium access control control element (MAC CE) command; and
wherein one or multiple of the second type TCI states for different link combination is selected by corresponding MAC CE command; and
wherein a higher layer parameter is used to indicate that one of TCI states is selected by a MAC CE command for at least one of the first, second, third or fourth forwarding link.

7. The wireless communication method of claim 2, wherein multiple sets of first type of TCI states are configured by Radio Resource Control (RRC) signaling for different links.

8. The wireless communication method of claim 1, wherein the beam indication is determined by spatial relations;
wherein the spatial relations are configured by Radio Resource Control (RRC) signaling;
wherein one of the spatial relations is selected by a medium access control control element (MAC CE) command; and
a higher layer parameter is used to indicate that the one of the spatial relations is selected by a MAC CE command.

9. The wireless communication method of claim 8, wherein the spatial relations are activated by a MAC CE command, and one of the activated spatial relations is selected by a DCI;
wherein the DCI for selecting the activated spatial relations comprises at least one of a time-frequency resource indication or a beam spatial parameter;
wherein a higher layer parameter is used to indicate that the one of the activated spatial relations is selected by a sounding reference signal resource indicator (SRI) field in the DCI; and
wherein the one of the activated spatial relations is selected by a field in the DCI.

10. The wireless communication method of claim 1, wherein the beam indication of one or more of the first, second, third, and fourth forwarding links is identical to the beam indication of one or more of the first and second communication links.

11. A wireless communication method comprising:
transmitting, by a wireless communication node to a network node, a beam indication for a network for one or more links comprising at least one of:
a first communication link from the wireless communication node to the network node;
a second communication link from the network node to the wireless communication node;
a first forwarding link from the wireless communication node to the network node;
a second forwarding link from the network node to the wireless communication node;
a third forwarding link from the network node to a user equipment, UE; or
a fourth forwarding link from the user equipment to the network node.

12. The wireless communication method of claim 11, wherein the beam indication for the links is determined by a Transmission Configuration Indicator (TCI); and
wherein multiple sets of first type of TCI states are configured by Radio Resource Control (RRC) signaling for different links.

13. The wireless communication of claim 12, wherein a first type TCI is associated to each of the links;
wherein a downlink control information (DCI) for indicating the TCI state is scrambled by using a first Radio Network Temporary Identifier (RNTI), and the first RNTI is different from a second RNTI for scrambling DCI corresponding to a communication unit of the network node;
wherein the DCI for indicating the TCI state for the at least one of communication link is scrambled by using a first RNTI, and the first RNTI is different from a second RNTI for scrambling DCI for indicating the TCI state for the at least one of forwarding link;
wherein the DCI for indicating the TCI state has a first DCI format, and the first DCI format is different from a second DCI format DCI corresponding to a communication unit of the network node;
wherein the DCI for indicating the TCI state in the first DCI format comprises one or more TCIs for one or more of the first, second, third and fourth forwarding links respectively;
wherein a higher layer parameter is used to indicate that the indication of beam information via DCI is enabled.

14. The wireless communication of claim 12, wherein a second type TCI is associated to the one or more links;
wherein each of second type TCI state comprises a first part and a second part, the first part configures information for at least one of the first or second communication link, and a second part configures information for at least one of the first, second, third or fourth forwarding link; and
wherein each of second type TCI state comprises a first part and a second part, the first part configures information for at least one of the first, second, third or fourth forwarding link, and a second part configures information for at least one of the first, second, third or fourth forwarding link.

15. The wireless communication method of claim 12, wherein all or partially signal of the beam indication is transmitted by an Operations Administration and Maintenance (OAM) from network to a network node; and wherein the indicated TCI state via DCI is configured by the OAM.

16. The wireless communication method of claim 12, wherein TCI states are configured by Radio Resource Control (RRC) signaling;
wherein each of second type TCI state comprises a first part and a second part, the first part configures information for at least one of the first or second communication link, and a second part configures information for at least one of the first, second, third or fourth forwarding link;
wherein each of second type TCI state configuration comprises a first part and a second part, the first part configures information for at least one of the first, second, third or fourth forwarding link, and a second part configures information for at least one of the first, second, third or fourth forwarding link;
wherein one or multiple of the first type TCI states for different link is selected by a corresponding medium access control control element (MAC CE) command;
wherein one or multiple of the second type TCI states for different link combination is selected by a corresponding MAC CE command; and
wherein a higher layer parameter is used to indicate that one of TCI states is selected by a MAC CE command for at least one of the first, second, third or fourth forwarding link.

17. The wireless communication method of claim 11, wherein the beam indication is determined by spatial relations;
wherein the spatial relations are configured by Radio Resource Control (RRC) signaling;
wherein one of the spatial relations is selected by a medium access control control element (MAC CE) command; and
wherein a higher layer parameter is used to indicate that the one of the spatial relations is selected by a MAC CE command.

18. The wireless communication method of claim 17, wherein the spatial relations are activated by a MAC CE command, and one of the activated spatial relations is selected by downlink control information (DCI);
wherein the DCI for selecting the activated spatial relations comprises at least one of a time-frequency resource indication or a beam spatial parameter;
wherein a higher layer parameter is used to indicate that the one of the activated spatial relations is selected by a sounding reference signal resource indicator (SRI) field in the DCI; and
wherein the one of the activated spatial relations is selected by a field in DCI.

19. The wireless communication method of claim 11, wherein the beam indication of one or more of the first, second, third, and fourth forwarding links is identical to the beam indication of one or more of the first and second communication links.

20. A wireless communication node, comprising:
a communication unit configured to: receive a beam indication for a network for one or more links comprising at least one of:
a first communication link from a wireless communication node to the network node;
a second communication link from the network node to the wireless communication node;
a first forwarding link from the wireless communication node to the network node;
a second forwarding link from the network node to the wireless communication node;
a third forwarding link from the network node to a user equipment (UE); or
a fourth forwarding link from the user equipment to the network node.
